(19) United States
(12) Patent Application Publication
(10) Pub. No.: US 2024/0208283 A1
(43) Pub. Date: Jun. 27, 2024

(54) ROTARY JOINT ASSEMBLY FOR A TIRE INFLATION SYSTEM

(71) Applicant: DANA ITALIA S.R.L., Arco (IT)

(72) Inventors: Davide DEIMICHEI, Ala (IT); Fabrizio DENEI, Riva del Garda (IT); Nicola TESSARO, Riva del Garda (IT); Alberto CIS, Ledro (IT); Andrea BORTOLI, Rovereto (IT)

(21) Appl. No.: 18/392,497

(22) Filed: Dec. 21, 2023

(30) Foreign Application Priority Data
Dec. 22, 2022 (DE) 20 2022 107 180.2

(51) Int. Cl. B60C 29/06; F16J 15/16

(52) U.S. Cl. CPC B60C 29/06; F16J 15/162; F16J 15/164; F16J 15/3204

(57) ABSTRACT

A rotary joint assembly for a tire inflation system is provided. The assembly includes an air seal for sealing an air passage, a lubricant seal for sealing the air seal from a lubricant, and a leakage reception space delimited by the air seal and the lubricant seal and fluidically isolated from the atmosphere.

### CROSS-REFERENCE TO RELATED APPLICATION

The present application claims priority to German Utility Model Application No. 20 2022 107 180.2, entitled “ROTARY JOINT ASSEMBLY FOR A TIRE INFLATION SYSTEM”, and filed on Dec. 22, 2022. The entire contents of the above-listed application is hereby incorporated by reference for all purposes.

### TECHNICAL FIELD

The present disclosure relates to a rotary joint assembly for a tire inflation system. For example, rotary joint assemblies may be installed on working machines such as tractors, wheel loaders, dumpers, wheeled excavators, or the like.

### BACKGROUND AND SUMMARY

Tire inflation systems may be utilized to measure and adjust the pneumatic pressure of a vehicle tire to improve the maneuverability of the vehicle and to reduce fuel consumption when the vehicle drives on different terrain types. For example, the pressure of a vehicle tire may be lowered to provide additional traction for the vehicle when the vehicle travels on soft terrain such as sand or mud, or the tire pressure may be raised to reduce the rolling resistance of the vehicle when the vehicle travels on an asphalt road. Tire inflation systems typically comprise a stationary portion such as a spindle including a first fluid line, a rotatable portion such as a wheel hub including a second fluid line, and a rotary joint including a sealed fluid passage which provides fluidic communication between the first fluid line and the second fluid line including when the vehicle is moving.

For instance, WO 2013/156430 A1 discloses a spindle assembly for a tire inflation system, wherein a fluid conduit extending through a spindle is in fluidic communication with a fluid passage extending through a rotatable part via an annular seal chamber. Fluid leaked out of the annular seal chamber may be exhausted to the atmosphere via a breather line.

There continues to be demand for a rotary joint assembly which reduces the risk of lubricant or dirt contaminating seals of the rotary joint assembly.

A rotary joint assembly which meets this demand is defined as described herein.

The presently proposed rotary joint assembly for a tire inflation system comprises:
an air seal for sealing an air passage,
a lubricant seal for sealing the air seal from a lubricant, and
a leakage reception space delimited by the air seal and the lubricant seal and
fluidically isolated from the atmosphere.

For example, a pneumatic pressure in the leakage reception space is not be actively controllable by a pressure control device such as a valve, a compressor, or the like.

The fact that the leakage reception space is fluidically isolated from the atmosphere may prevent dust or dirt from entering the leakage reception space. In this way, the sealing function and the longevity of the air seal and/or of the lubricant seal may be improved, for example.

The rotary joint assembly may include a stationary portion such as a spindle or an axle housing. The stationary portion may comprise a first fluid line in fluidic communication with the air passage. Also, the rotary joint assembly may include a rotatable portion such as a wheel or a wheel hub. The rotatable portion may comprise a second fluid line in fluidic communication with the air passage. A rotation axis of the rotatable portion may then define an axial direction and radial directions perpendicular to the axial direction. Typically, the air passage is configured to provide fluidic communication between the first fluid line and the second fluid line. For example, the first fluid line may be fluidically connected or fluidically connectable to a pressure source such as a compressor, and/or to the atmosphere. And the second fluid line may be fluidically connected or fluidically connectable to a pneumatic tire mounted on or configured to be mounted on the rotatable portion. The pneumatic tire may then be inflated and/or deflated via the first fluid line, the air passage and the second fluid line.

The leakage reception space may be delimited by the stationary portion and/or by the rotatable portion. For example, the leakage reception space may be formed or at least partially formed by a recess formed in the stationary portion and/or in the rotatable portion. In this way, the volume of the leakage reception space may be enlarged, thereby decreasing a pneumatic pressure in the leakage reception space and improving the functionality and/or the longevity of the air seal and/or of the lubricant seal.

The rotary joint assembly may include a bushing. The bushing may be mounted on the stationary portion. Alternatively, the bushing may be mounted on the rotatable portion. The bushing may have a sleeve-like shape. The bushing may be made of a metal such as steel. However, it is understood that the bushing may be made of or may include other materials. The leakage reception space may be delimited or at least partially delimited by the bushing. For example, the leakage reception space may be formed or at least partially formed by a recess formed in the bushing. More specifically, said recess may be formed on a radially inner side of the bushing, i.e. on a side of the bushing facing the rotation axis. For instance, the recess may include an annular notch or groove formed in the bushing. In this way, the volume of the leakage reception space may be enlarged, thereby decreasing a pneumatic pressure in the leakage reception space and improving the functionality and/or the longevity of the air seal and/or of the lubricant seal. The first fluid line of the stationary portion may be in fluidic communication with the air passage via a conduit or boring formed in the bushing, for example.

The rotary joint assembly may include at least one sealing member sealing the leakage reception space. The at least one sealing member may be disposed on the radially inner side of the bushing. The at least one sealing member may include a sealing ring received in an indentation formed in the bushing or in the stationary portion. At least one of the air seal and the lubricant seal may be in sliding sealing contact with the bushing. However, it is understood that in embodiments which do not include a bushing the air seal and/or the lubricant seal may be in sliding sealing engagement with the stationary portion, or the air seal and/or the lubricant seal may be in sliding sealing engagement with the rotatable portion.

The rotary joint assembly may include a first bearing and a second bearing such as for rotatably mounting the rotatable portion on the stationary portion. The bushing may then be diposed in between the first bearing and the second bearing. More specifically, the bushing may be disposed in between the first bearing and the second bearing along the rotation axis. For example, the bushing may be diposed in between an inner ring or an outer ring of the first bearing and an inner ring or an outer ring of the second bearing.

Along the radial direction perpendicular to the rotation axis an axial extension of the leakage reception space may vary, for example by a factor of two or more, or by a factor of three or more.

In the following, embodiments of the presently proposed rotary joint assembly are described with reference to the accompanying drawing.

### BRIEF DESCRIPTION OF THE FIGURES

FIG. 1 shows a sectional view of a rotary joint assembly according to a first embodiment.

FIG. 2 shows a sectional view of a rotary joint assembly according to a second embodiment.

FIG. 3 shows a sectional view of a rotary joint assembly according to a second embodiment.

FIG. 4 shows a sectional view of a rotary joint assembly according to a fourth embodiment.

### DETAILED DESCRIPTION

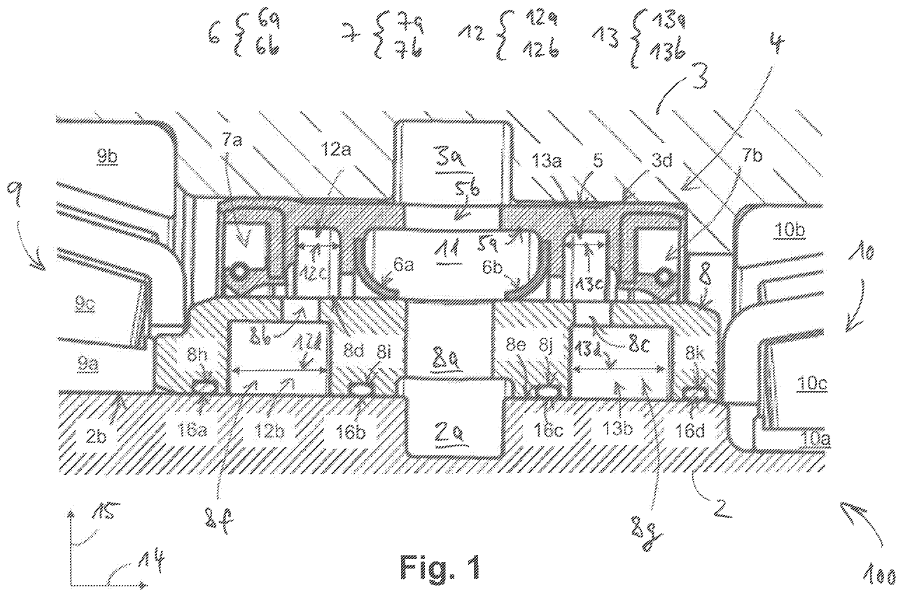

FIG. 1 illustrates a rotary joint assembly 100 for a tire inflation system for an automotive vehicle according to a first embodiment. The rotary joint assembly 100 includes a stationary portion 2 such as a spindle or an axle housing and a rotatable portion 3 such as a wheel or wheel hub. In the embodiment of FIG. 1, the rotatable portion 3 is rotatably mounted on the stationary portion 2 by means of axially spaced roller bearings 9, 10. The roller bearings each include an inner ring 9a, 10a mounted on the stationary portion 2, an outer ring 9b, 10b mounted on or attached to the rotatable portion 3, and a plurality of rollers 9c, 10c disposed in between the inner ring 9a, 10a and the outer ring 9b, 10b, respectively. A rotation axis of the rotatable portion 3 extends in parallel to an axial direction 14 and is arranged below the bearings 9, 10. A radial direction 15 extends perpendicular to the axial direction 14. In the embodiment depicted here, the rotatable portion 3 encloses or surrounds the stationary portion 2 in the radial direction. However, it is understood that in other embodiments not explicitly depicted here the stationary portion 2 may enclose or surround the rotatable portion 3 in the radial direction.

The stationary portion 2 includes a first fluid line 2a, and the rotatable portion 3 includes a second fluid line 3a. In the embodiment depicted in FIG. 1, the fluid lines 2a, 3a may at least partially extend in a circumferential direction perpendicular to the plane of projection of FIG. 1, for example. The first fluid line 2a or a portion thereof may be integrally formed with the stationary portion 2. For example, the first fluid line 2a may include a circumferentially extending notch and/or a boring in the stationary portion 2. Similarly, the second fluid line 3a or a portion thereof may be integrally formed with the rotatable portion 3. For example, the second fluid line 3a may include a circumferentially extending notch and/or a boring in the rotatable portion 3. The first fluid line 2a and the second fluid line 3a are in fluidic communication with one another, as will be explained in some further detail below. The first fluid line 2a may be in fluidic communication or in selective fluidic communication with a pressure source such as a compressor. Additionally or alternatively, the first fluid line 2a may be in fluidic communication or in selective fluidic communication with a low pressure tank or with the atmosphere. By contrast, the second fluid line 3a may be in fluidic communication or in selective fluidic communication with a pneumatic tire which may be mounted on the rotatable portion 3. In this way, a pneumatic tire mounted on the rotatable portion 3 may be inflated and/or deflated via the first fluid line 2a and the second fluid line 3a.

The rotary joint assembly 100 also includes a sleeve-like bushing 8. Here, the bushing 8 is mounted on the stationary portion 2. More specifically, the sleeve-like bushing 8 is disposed on an outer circumference 2b of the stationary portion 2. Or in other words, in the radial direction 15 the bushing 8 is disposed in between the stationary portion 2 and the rotatable portion 3. However, it is understood that some embodiments may not include a bushing.

In the embodiment depicted here, the outer circumference 2b of the stationary portion 2 and a radially inner surface 8e of the bushing 8 each have a cylindrical shape or an essentially cylindrical shape. The radially inner surface 8e of the bushing 8 faces the rotation axis of the rotatable portion 3, i.e. toward the bottom in FIG. 1. An inner diameter of the bushing 8 may be equal to or just slightly larger than an outer diameter of the stationary portion 2. For example, the bushing 8 may be fixedly mounted on the stationary portion 2. The bushing 8 may be made of a metal such as steel. However, it is understood that the bushing 8 may be made of or may include other materials. In the embodiment depicted in FIG. 1, the bushing 8 is axially held in place on the stationary portion 2 by the inner ring 9a of the first bearing 9 and by the outer ring 10b of the second bearing 10. The bushing 8 includes a radially extending boring 8a providing fluidic communication between the first fluid line 2a of the stationary portion 2 and the second fluid line 3a of the rotatable portion 3. For example, the boring 8a may fluidically connect a radially outer surface 8d of the bushing 8 with an annular notch 8f formed in the radially inner surface 8e of the bushing 8. The radially outer surface 8d of the bushing 8 faces away from the rotation axis of the rotatable portion 3, i.e. upward in FIG. 1. The annular notch 8f may extend around the entire circumference 2d of the stationary portion 2, for example.

Further, the rotary joint assembly 100 includes a sealing assembly 4. The sealing assembly 4 is disposed radially in between the stationary portion 2 and the rotatable portion 3. More specifically, in the embodiment depicted in FIG. 1 the sealing assembly 4 is disposed radially in between the bushing 8 and the rotatable portion 3. The sealing assembly 4 seals an air passage 11 fluidically connecting the first fluid line 2a with the second fluid line 3a.

In the embodiment of FIG. 1, the sealing assembly 4 includes an air seal assembly 6 sealing the air passage 11, and a lubricant seal assembly 7 sealing or protecting the air seal assembly 6 from lubricant used to lubricate the bearings 9, 10. Here, the air passage 11 extends in the radial direction 15. Along the axial direction 14 the air passage 11 is disposed in between the roller bearings 9, 10. The air seal assembly 6 includes axially spaced air seals 6a, 6b, here in the form of annular sealing lips. The air seals 6a, 6b may be made of or may comprise a plastic material such as PTFE, for example. In the embodiment depicted here, each of the air seals 6a, 6b includes a single sealing lip. In other embodiments not illustrated here, each of the air seals 6a, 6b may include a double sealing lip, for example. The air seals 6a, 6b are in sliding sealing engagement with the radially outer surface 8d of the bushing 8. It is understood that in embodiments that do not include a bushing, the air seals 6a, 6b may be in sliding sealing engagement with the stationary portion 2 or possibly with the rotatable portion 3. In the embodiment depicted in FIG. 1, the air seals 6a, 6b have a convex shape so that a high pressure in the air passage 11 presses the air seals 6a, 6b into sealing engagement or further into sealing engagement with the outer surface 8d of the bushing 8. The air seals 6a, 6b may extend around the entire circumference of the radially outer surface 8d of the bushing 8. Or in other words, the air passage 11 may have an annular shape and extend around the entire circumference of the radially outer surface 8d of the bushing 8.

The lubricant seal assembly 7 includes lubricant seals 7a, 7b, here in the form of annular sealing lips. The lubricant seals 7a, 7b protect the air seals 6a, 6b and the air passage 11 from lubricant which is used to lubricate the bearings 9, 10, respectively. The lubricant seals 7a, 7b may be made of or may comprise a plastic material, for example. In the embodiment depicted in FIG. 1, the lubricant seals 7a, 7b are in sliding sealing engagement with the radially outer surface 8d of the bushing 8. It is understood that in embodiments that do not include a bushing, the air seals 6a, 6b may be in sliding sealing engagement with the stationary portion 2 or possibly with the rotatable portion 3. The lubricant seal 7a is disposed axially in between the bearing 9 and the air seal 6a. Or in other words, the lubricant seal 7a is axially spaced from the bearing 9 and from the air seal 6a. Similarly, the lubricant seal 7b is disposed axially in between the bearing 10 and the air seal 6b. Or in other words, the lubricant seal 7b is axially spaced from the bearing 10 and from the air seal 6b.

In the embodiment depicted in FIG. 1, both the air seals 6a, 6b and the lubricant seals 7a, 7b are fixed with respect to the rotatable portion 3. More specifically, the sealing assembly 4 includes a seal carrier ring 5 fixed to the rotatable portion 3, and the air seals 6a, 6b and the lubricant seals 7a, 7b are attached to the seal carrier ring 5. For example, the seal carrier ring 5 may be press-fit to the rotatable portion 3. The seal carrier ring 5 is disposed radially in between the stationary portion 2 and the rotatable portion 3, more specifically in between the bushing 8 and the rotatable portion 3. The air seals 6a, 6b and the lubricant seals 7a, 7b are mounted on a radially inner side 5a of the seal carrier ring 5. The radially inner side 5a of the seal carrier ring 5 faces the rotation axis of the rotatable portion 3. A radially extending boring 5b in the seal carrier ring 5 provides fluidic communication between the air passage 11 and the second fluid line 3a in the rotatable portion 3.

When inflating a pneumatic tire mounted on the rotatable portion 3 by pumping compressed air through the first fluid line 2a, the boring 8a, the air passage 11 and the second fluid line 3a, some air may leak through the air seals 6a, 6b sealing the fluid passage 11. Air leaked through the air seal 6a is received in a leakage reception space 12, and air leaked through the air seal 6b is received in a leakage reception space 13. In the embodiment depicted in FIG. 1, the leakage reception spaces 12, 13 are disposed radially in between the stationary portion 2 and the rotatable portion 3. By contrast, along the axial direction 14 the leakage reception spaces 12, 13 are disposed in between the bearings 9, 10. The leakage reception spaces 12, 13 are fluidically isolated from the atmosphere. For instance, the leakage reception spaces 12, 13 are not in fluidic communication with the atmosphere via a pressure control device such as a valve, a pump, a compressor, or the like. The leakage reception space 12 comprises a first compartment 12a and a second compartment 12b. Analogously, the leakage reception space 13 comprises a first compartment 13a and a second compartment 13b.

Along the axial direction 14 the first compartment 12a of the leakage reception space 12 is delimited by the air seal 6a and the lubricant seal 7a. By contrast, along the radial direction 15 the first compartment 12a of the leakage reception space 12 is delimited by the radially outer surface 8d of the bushing 8 and the seal carrier ring 5. Here, the first compartment 12a has an annular shape and extends around the entire radially outer surface 8d of the bushing 8.

The second compartment 12b of the leakage reception space 12 is formed by a notch 8f formed on the radially inner surface 8e of the bushing 8. The notch 8f may have an annular shape and extend around the entire outer circumference 2d of the stationary portion 2. Along the axial direction 14 the second compartment 12a of the leakage reception space 12 is delimited by the bushing 8. By contrast, along the radial direction 15 the second compartment 12a of the leakage reception space 12 is delimited by the outer circumference 2d of the stationary portion 2 and by the bushing 8. The first compartment 12a and the second compartment 12b of the leakage reception space are in fluidic communication via a radially extending boring 8b in the bushing 8.

The sealing assembly 4 further includes two sealing rings 16a, 16b sealing the second compartment 12b of the leakage reception space 12. The sealing rings 16a, 16b may be made of or may comprise rubber, for example. Along the axial direction 14 the sealing rings 16a, 16b are disposed on either side of the second compartment 12b. By contrast, along the radial direction 15 the sealing rings 16a, 16b are disposed in between the stationary portion 2 and the bushing 8. More specifically, the sealing rings 16a, 16b are received in annular indentations 8h, 8i formed on the radially inner side 8e of the bushing 8, respectively.

A volume of the second compartment 12b of the leakage reception space 12 may be larger than a volume of the first compartment 12a of the leagage reception space 12, for example by a factor of two or more. For example, a greatest axial extension 12d of the leakage reception space 12 in the second compartment 12b may be larger than a smallest axial extension 12c of the leakage reception space 12 in the first compartment 12a, for example by a factor of two or more.

Along the axial direction 14 the first compartment 13a of the leakage reception space 13 is delimited by the air seal 6b and the lubricant seal 7b. By contrast, along the radial direction 15 the first compartment 13a of the leakage reception space 13 is delimited by the radially outer surface 8d of the bushing 8 and the seal carrier ring 5. Here, the first compartment 13a has an annular shape and extends around the entire radially outer surface 8d of the bushing 8.

The second compartment 13b of the leakage reception space 13 is formed by a notch 8g formed on the radially inner surface 8e of the bushing 8. The notch 8g may have an annular shape and extend around the entire outer circumference 2d of the stationary portion 2. Along the axial direction 14 the second compartment 13a of the leakage reception space 13 is delimited by the bushing 8. By contrast, along the radial direction 15 the second compartment 13a of the leakage reception space 13 is delimited by the outer circumference 2d of the stationary portion 2 and by the bushing 8. The first compartment 13a and the second compartment 13b of the leakage reception space are in fluidic communication via a radially extending boring 8c in the bushing 8.

The sealing assembly 4 further includes two sealing rings 16c, 16d sealing the second compartment 13b of the leakage reception space 13. The sealing rings 16c, 16d may be made of or may comprise rubber, for example. Along the axial direction 14 the sealing rings 16c, 16d are disposed on either side of the second compartment 13b. By contrast, along the radial direction 15 the sealing rings 16c, 16d are disposed in between the stationary portion 2 and the bushing 8. More specifically, the sealing rings 16c, 16d are received in annular indentations 8j, 8k formed on the radially inner side 8e of the bushing 8, respectively. The sealing rings 16b, 16c further seal the fluidic connection between the first fluid line 2a in the stationary portion 2 and the second fluid line 3a in the rotatable portion 3 from the leakage reception spaces 12, 13, more specifically from the second compartments 12b, 13b of the leakage reception spaces 12, 13.

A volume of the second compartment 13b of the leakage reception space 13 may be larger than a volume of the first compartment 13a of the leagage reception space 13, for example by a factor of two or more. For example, a greatest axial extension 13d of the leakage reception space 13 in the second compartment 13b may be larger than a smallest axial extension 13c of the leakage reception space 13 in the first compartment 13a, for example by a factor of two or more.

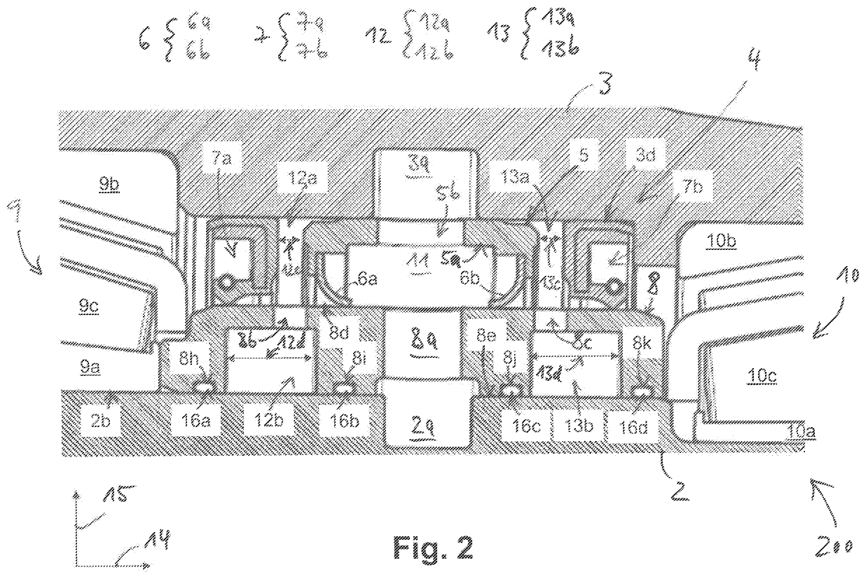

FIG. 2 illustrates a rotary joint assembly 200 for a tire inflation system for an automotive vehicle according to a second embodiment. Here and in all of the following, features recurring in different figures are designated with the same reference signs. Please also see the list of reference signs at the end of this description. The rotary joint assembly 200 of FIG. 2 is a variation of the rotary joint assembly 100 of FIG. 1. Therefore, for matters of brevity and simplicity, in the following only those features of the rotary joint assembly 200 of FIG. 2 which distinguish it from the rotary joint assembly 100 of FIG. 1 are described in some detail. Unless explicitly stated to the contrary, the rotary joint assembly 200 of FIG. 2 may include the same features as the rotary joint assembly 100 of FIG. 1 described above.

In contrast to the rotary joint assembly 100 of FIG. 1, the seal assembly 4 of the rotary joint assembly 200 of FIG. 2 does not include a single seal carrier ring such as the seal carrier ring 5 depicted in FIG. 1 to which all seals 6a, 6b, 7a, 7b are attached. For example, in the rotary joint assembly 200 of FIG. 2 only the air seals 6a, 6b are attached to the seal carrier ring 5 while the lubricant seals 7a, 7b are attached to the rotatable portion 3. Consequently, in the radial direction 15 the compartments 12a, 13a of the leakage reception spaces 12, 13 are delimited by the rotatable portion 13. And further in contrast to the rotary joint assembly 100 of FIG. 1, in the rotary joint assembly 200 of FIG. 2, a greatest axial extension 12d, 13d of the leakage reception spaces 12, 13 in the second compartments 12b, 13b is larger than a smallest axial extension 12c, 13c of the leakage reception spaces 12, 13 in the first compartments 12a, 13a by a factor of three or more, respectively. Again, in the rotary seal assembly 200 of FIG. 2 the leakage reception spaces 12, 13 are fluidically isolated from the atmosphere. For instance, the leakage reception spaces 12, 13 are not in fluidic communication with the atmosphere via a pressure control device such as a valve, a pump, a compressor, or the like.

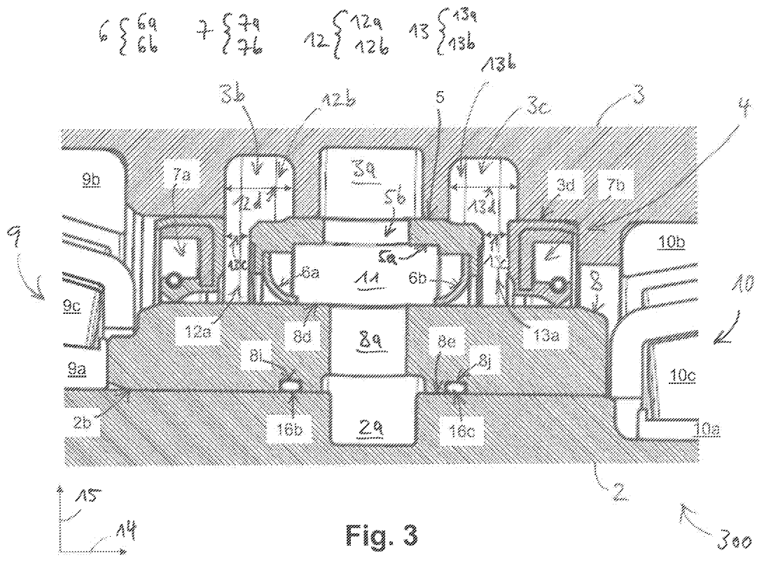

FIG. 3 illustrates a rotary joint assembly 300 for a tire inflation system for an automotive vehicle according to a third embodiment. Again, features recurring in different figures are designated with the same reference signs. Please also see the list of reference signs at the end of this description. The rotary joint assembly 300 of FIG. 3 is a variation of the rotary joint assembly 100 of FIG. 1. Therefore, for matters of brevity and simplicity, in the following only those features of the rotary joint assembly 300 of FIG. 3 which distinguish it from the rotary joint assembly 100 of FIG. 1 are described in some detail. Unless explicitly stated to the contrary, the rotary joint assembly 300 of FIG. 3 may include the same features as the rotary joint assembly 100 of FIG. 1 described above.

In contrast to the rotary joint assembly 100 of FIG. 1, the seal assembly 4 of the rotary joint assembly 200 of FIG. 2 does not include a single seal carrier ring such as the seal carrier ring 5 depicted in FIG. 1 to which all seals 6a, 6b, 7a, 7b are attached. For example, in the rotary joint assembly 200 of FIG. 2 only the air seals 6a, 6b are attached to the seal carrier ring 5 while the lubricant seals 7a, 7b are attached to the rotatable portion 3. Consequently, in the radial direction 15 the leakage reception spaces 12, 13 are delimited by the rotatable portion 13.

And further in contrast to the rotary joint assembly 100 of FIG. 1, the second compartments 12b, 13b of the leakage reception spaces 12, 13 of the rotary joint assembly 300 of FIG. 3 are not formed by notches in the bushing 8, but by notches 3b, 3c formed on a radially inner side 3d of the rotatable portion 3. The radially inner side 3d of the rotatable portion 3 faces the rotation axis of the rotatable portion 3, i.e. toward the bottom in FIG. 3. That is, in the embodiment shown in FIG. 3 in the radial direction 15 the leakage reception spaces 12, 13 are disposed completely in between the bushing 8 and the rotatable portion 3. Again, in the rotary seal assembly 300 of FIG. 3 the leakage reception spaces 12, 13 are fluidically isolated from the atmosphere. For instance, the leakage reception spaces 12, 13 are not in fluidic communication with the atmosphere via a pressure control device such as a valve, a pump, a compressor, or the like.

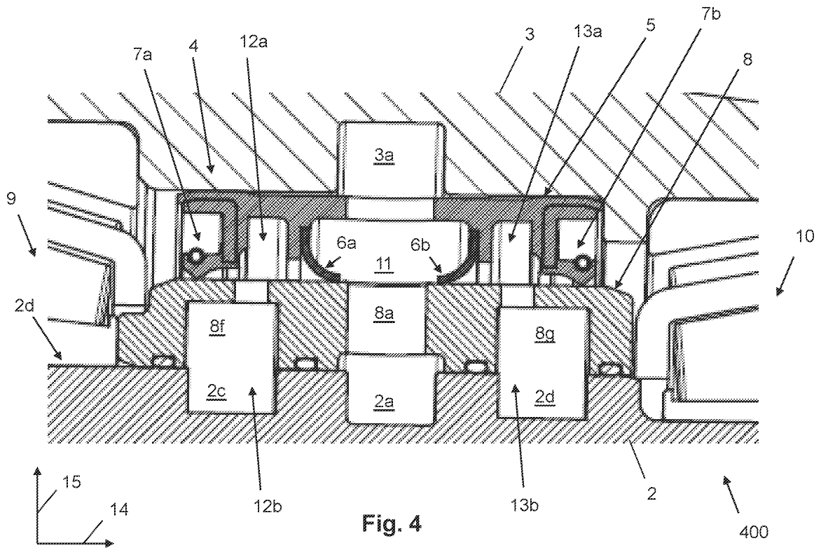

FIG. 4 illustrates a rotary joint assembly 400 for a tire inflation system for an automotive vehicle according to a fourth embodiment. As before, features recurring in different figures are designated with the same reference signs. Please also see the list of reference signs at the end of this description. The rotary joint assembly 400 of FIG. 4 is a variation of the rotary joint assembly 100 of FIG. 1. Therefore, for matters of brevity and simplicity, in the following only those features of the rotary joint assembly 400 of FIG. 4 which distinguish it from the rotary joint assembly 100 of FIG. 1 are described in some detail. Unless explicitly stated to the contrary, the rotary joint assembly 400 of FIG. 4 may include the same features as the rotary joint assembly 100 of FIG. 1 described above.

In contrast to the rotary joint assembly 100 of FIG. 1, in the rotary joint assembly 400 of FIG. 4 the second compartments 12b, 13b of the leakage reception spaces 12, 13 are at least partially formed by notches 2c, 2d formed in the outer circumference 2b of the stationary portion 2, thereby complementing the notches 8f, 8g formed in the radially inner side 8e of the bushing 8, respectively. Again, in the rotary seal assembly 400 of FIG. 4 the leakage reception spaces 12, 13 are fluidically isolated from the atmosphere. For instance, the leakage reception spaces 12, 13 are not in fluidic communication with the atmosphere via a pressure control device such as a valve, a pump, a compressor, or the like.

The figures show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A rotary joint assembly for a tire inflation system, comprising:
an air seal for sealing an air passage,
a lubricant seal for sealing the air seal from a lubricant, and a leakage reception space delimited by the air seal and the lubricant seal and fluidically isolated from the atmosphere.

2. The rotary joint assembly of claim 1, further comprising a stationary portion comprising a first fluid line in fluidic communication with the air passage.

3. The rotary joint assembly of claim 2, wherein the leakage reception space is delimited by the stationary portion.

4. The rotary joint assembly of claim 3, wherein the leakage reception space is formed by a recess formed in the stationary portion.

5. The rotary joint assembly of claim 2, further including a bushing.

6. The rotary joint assembly of claim 5, wherein the bushing is mounted on the stationary portion.

7. The rotary joint assembly of claim 5, wherein the leakage reception space is delimited by the bushing.

8. The rotary joint assembly of claim 7, wherein the leakage reception space is formed by a recess formed in the bushing.

9. The rotary joint assembly of claim 8, wherein the recess is formed on a radially inner side of the bushing.

10. The rotary joint assembly of claim 9, further comprising at least one sealing member disposed on the radially inner side of the bushing and sealing the leakage reception space.

11. The rotary joint assembly of claim 10, wherein the at least one sealing member comprises a sealing ring received in an indentation formed in the bushing or in the stationary portion.

12. The rotary joint assembly of claim 4, wherein at least one of the air seal and the lubricant seal is in sliding sealing engagement with the bushing.

13. The rotary joint assembly of claim 4, further comprising a first bearing and a second bearing, wherein the bushing is disposed in between the first bearing and the second bearing.

14. The rotary joint assembly of claim 1, further including a rotatable portion comprising a second fluid line in fluidic communication with the air passage.

15. The rotary joint assembly of claim 14, wherein the leakage reception space is delimited by the rotatable portion.

16. The rotary joint assembly of claim 15, wherein the leakage reception space is formed by a recess formed in the rotatable portion.

17. The rotary joint assembly of claim 14, wherein the rotatable portion defines a rotation axis, and wherein along a radial direction perpendicular to the rotation axis an axial extension of the leakage reception space varies by a factor of two or more.
